(19) United States
(12) Patent Application Publication
(10) Pub. No.: US 2004/0152503 A1
(43) Pub. Date: Aug. 5, 2004

(54) Method, system, and program product for providing predetermined-prize bonus round play in a game

(76) Inventors: Jefferson Craig Lind, Austin, TX (US); Clint Alan Owen, Rockdale, TX (US)

Correspondence Address: Russell D. Culbertson, Suite 420, 1114 Lost Creek Blvd., Austin, TX, 78746, US

(21) Appl. No.: 10/726,448

(22) Filed: Dec. 3, 2003

Related U.S. Application Data
(60) Provisional application No. 60/444,503, filed on Feb. 3, 2003.
(60) Provisional application No. 60/506,454, filed on Sep. 26, 2003.

(51) Int. Cl. A63F 9/24; A63F 13/00

(52) U.S. Cl. 463/16; 463/25

(57) ABSTRACT

In a method, apparatus and program product for adding a “predetermined-prize bonus” round to a game, such a bonus round includes activity that leads to the revealing of a hidden result for the game. Where the underlying game comprises a bingo game, the game play result includes a bingo card pattern and payout amount for an otherwise ordinary result of the game. A player makes a selection in the predetermined-prize bonus round, but the selection has no affect on the amount awarded for the game, since the amount is determined prior to the player's selection.

### CROSS-REFERENCE TO RELATED APPLICATIONS

The present application is related to the following applications.

(1) U.S. Provisional Patent Application No. 60/444,503, filed Feb. 3, 2003, and entitled “Rapid Play Electronic Bingo Gaming System.” (2) U.S. patent application Ser. No. 10/456,721, filed Jun. 6, 2003, and entitled “Method, System, and Program Product for Conducting Multiple Concurrent Bingo-Type Games.” (3) U.S. patent application Ser. No. 10/455,905, filed Jun. 6, 2003, and entitled “Method, System, and Program Product for Conducting Bingo Games.”

The entire content of each of these applications is hereby incorporated herein by reference.

The Applicants claim the benefit, under 35 U.S.C. § 19(e), of U.S. Provisional Patent Application 60/506,454 filed Sep. 26, 2003 and entitled METHOD, SYSTEM, AND PROGRAM PRODUCT FOR PROVIDING PREDETERMINED-PRIZE BONUS ROUND PLAY IN A GAME. The entire content of this provisional application is incorporated herein by this reference.

### TECHNICAL FIELD OF THE INVENTION

This invention relates to electronic gaming systems that enable players to participate in bingo games, including such games in which there are players in many different locations. More particularly, the invention is directed to apparatus, methods, and program products for aiding players in the rapid, secure play of bingo games and for enhancing player participation in bingo games.

### BACKGROUND OF THE INVENTION

The game referred to generally as “bingo” is played with predetermined bingo cards having designations, such as numbers, letters or other symbols, randomly arranged in a grid or other layout on a bingo card. The locations of such designations on a bingo card are sometimes referred to as spots. Bingo cards may be physically printed on paper or another suitable material, or may be represented by a data structure that defines the various locations and the designations associated with the locations. In a traditional bingo game sequence, a number of predetermined bingo cards are put in play for a particular game. After the sale of bingo cards is closed for a given game, designations are randomly selected from a pool of available designations, such as by drawing marked balls from a tumbler. The selected designations are then matched to the designations on each bingo card that is in play for the game. This matching, which is commonly referred to as daubing the card, results in an individual pattern of matched spots for each card. In traditional bingo games daubing was done manually by the player holding a bingo card. Then, if the player's daubing indicated the card had a winning pattern, the card was again daubed by a game administrator in order to verify the winning pattern. More recent bingo game systems automatically check for winning patterns on a bingo card as designations are randomly selected for a game in lieu of or in addition to daubing by the player. Regardless of how the bingo cards in play for a game are daubed, the first card that is daubed in some predefined way is considered a winning card for the game.

Although traditional paper bingo games remain popular, the speed with which such traditional games are played is often an issue among today's players, who are increasingly accustomed to more fast-paced entertainment. That is, certain steps in the traditional paper bingo game are relatively time consuming. These include time for card purchasing, i.e., a “buy-in” period, followed by a period of sequential ball draws, for which there is an announcement of each individual designation that is drawn, followed by a period to allow players to manually daub their card or cards, and then a time for winner verification. This time required to play a traditional bingo game tends to limit player excitement and satisfaction.

Various systems have been developed to aid players in playing bingo games and to enhance player participation in the games. The REEL TIME™ gaming system offered by Multimedia Games, Inc., includes a bingo gaming system in which players at different gaming facilities, which may be spaced apart over a large geographic area, may participate in bingo games. The players participate in bingo games in the REEL TIME™ system through electronic player stations maintained in various gaming facilities.

According to one embodiment of the REEL TIME™ gaming system, described in the above cross-referenced applications, players from one or more gaming locations electronically submit one or more cards. A game engine included in the system automatically groups the players, conducts the games, and then returns results to the participating players at their respective player stations. Returning a result includes communicating data that directly identifies the result of the game for a particular card, or data that indirectly identifies the result, such as through a look up table. The identified result is then presented at the respective player station in the form of a suitable graphical representation. The graphical representation may include the actual bingo pattern for the player's card and may also include a graphical depiction of some aspect of a game not traditionally related to a bingo game, such as a horse race, or a pattern of reel stop positions in a slot machine, for example. In some implementations a player may place more than one bingo card in play at a given time and results for the different cards are displayed in some unified graphical representation, such as a representation of a multi-line slot machine for example.

Electronic bingo game systems and electronic player stations like those employed in the REEL TIME™ gaming system may increase the speed at which certain operations in a bingo game may be performed, such as those time-consuming operations mentioned above, for example. However, even in electronically implemented bingo games, lottery games, and other electronically implemented games there is a need and opportunity for increasing player excitement and satisfaction.

### SUMMARY OF THE INVENTION

The present invention addresses the above-described need with a method, apparatus and program product for adding a “predetermined-prize” bonus round to a game, especially a bingo game. The predetermined-prize bonus round, which may be referred to hereafter simply as the “bonus round” includes at least one round of activity that allows a player to reveal a result in the game. For a bingo game, the result will be a result for a given bingo card in the bingo game. According to the invention, the result in the game is hidden or concealed from the game player while the player is presented with at least one set of selection options. The player is required to choose from among the selection options to reveal the result in the game. By requiring the player to make a selection or choice to see the game result, the bonus round activity makes the game more interactive and enhances player involvement in the game. In particular, the interactive engagement of the player and added suspense associated with the player's choice increases excitement and maintains or captures the player's interest in the game. However, the actual result is predetermined by the underlying game and is in fact unaffected by the player's choice or selection.

A system according to the invention typically includes a number of electronic player stations and a result server connected to the electronic player stations over a communications network. The result server may be made up of a single computer system in some systems while in other systems may actually include different computer systems at the same or different physical locations and which together produce or obtain game play results. Each electronic player station is used to generate a game play request in response to a player input at the player station. Each game play request entered at a player station is communicated to the result server or servers for obtaining a result for the game play request, that is, a game play result. For example, each game play request may be communicated to a server through a suitable communications arrangement, and the server may use the game play requests to conduct a game, such as a bingo-type game for example, and obtain a game play result for each respective game play request.

Regardless of how the result for a game play request in the underlying game is obtained, a suitable bonus round association controller included in the system associates certain game play results with the bonus round, while other game play results are not associated with the bonus round. For a given game play result that is not associated with the bonus round, a display controller included in the system responds to the game play result by causing a display associated with the player's electronic player station to display or show the game play result in some fashion. For a given game play result associated with the bonus round, the display controller included in the system responds to the game play result by causing the display at the player station to present the player with a number of selection options from which to choose. The display controller also causes the result which has been associated with the bonus round to be concealed or hidden until the player chooses one of the selection options, and then causes the result to be displayed to the player only after the player's selection of any one of the selection options.

The invention may be implemented through a program product stored on a computer readable medium and adapted to be executed by one or more processing devices, such as the display controller for example, to direct the respective processing device to perform its function in the system. In a particular embodiment, the program product includes primary display program code that responds to non bonus game play results that are not associated with the bonus round, and selection option display program code for responding to game play results that are associated with the bonus round. In particular, the primary display program code is executed to respond to a non bonus game play result by causing the player's display to reveal or display the non bonus game play result to the player. The selection option display program code is executed to respond to a game play result by causing a player display to present the game player with the selection options from which to choose in the bonus round. The program product according to one embodiment of the invention also includes bonus round display program code which is executed to cause the player display to display the game play result in response to the game player's selection of any one of the number of the selection options presented under control of the selection option display program code.

These and other advantages and features of the invention will be apparent from the following description of preferred embodiments, considered along with the accompanying drawings.

### BRIEF DESCRIPTION OF THE DRAWINGS

FIG. 1 is a diagrammatic representation of a bingo gaming system with which the present invention may be implemented.

FIG. 2 is a diagrammatic representation of a computer system arrangement that may be used for the central game server and local area servers included in the system shown in FIG. 1.

FIG. 3 is a diagrammatic representation of an electronic player station that may be used in the system shown in FIG. 1.

FIG. 4 is a diagrammatic representation of an embodiment of the present invention as implemented with the system shown in FIG. 1.

FIG. 5 is a diagram providing a description of a process embodying the principles of the present invention.

FIG. 6 is a representation of a player station display that may be used to communicate a game play result to a player where the game play result is not associated with a bonus round.

FIG. 7 is a representation of a player station display of selection options according to one embodiment of the invention.

FIG. 8 is a representation similar to FIG. 7, but showing the result revealed to the player.

### DESCRIPTION OF PREFERRED EMBODIMENTS

The claims at the end of this application set out novel features which the Applicants believe are characteristic of the invention. The invention, a preferred mode of use, further advantages and features of the invention, will best be understood by reference to the following detailed description of an illustrative embodiment read in conjunction with the accompanying drawings.

The present invention providing bonus round play may be used with many different types of games. In one particular embodiment of the invention, the underlying game comprises a bingo game. The invention will be described below primarily in connection with this particular bingo embodiment. However, it should be noted that the invention is not limited to providing bonus round play in bingo or bingo-type games. Rather, the invention may be used to provide bonus round play for lottery games and many other types of games.

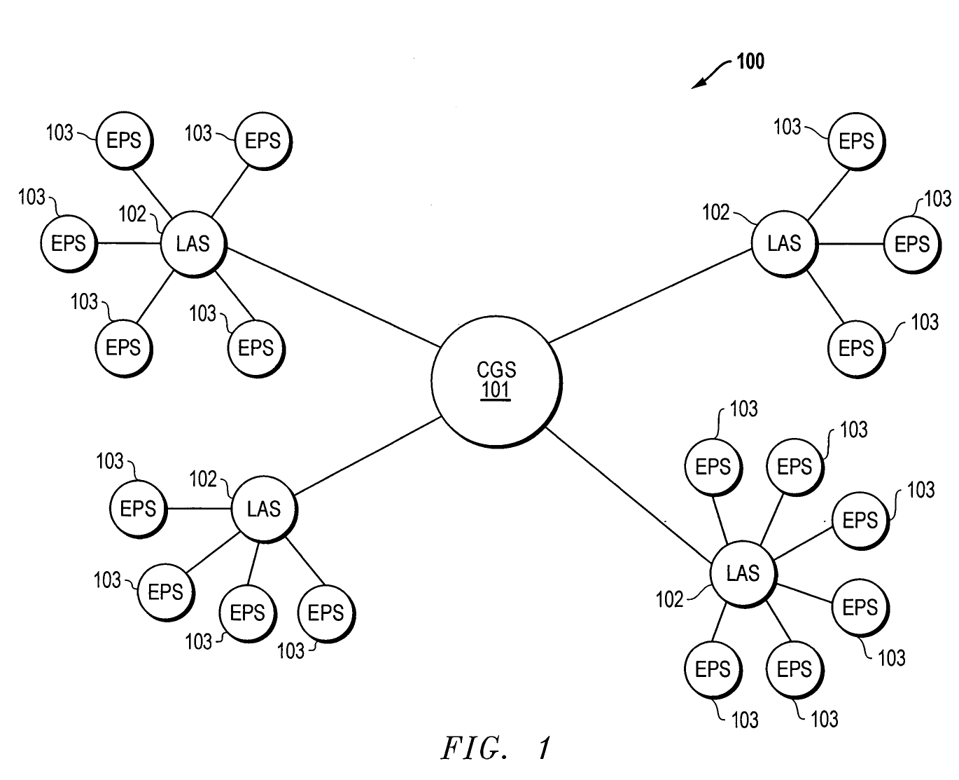

FIG. 1 shows a gaming system 100 including a central game server (CGS) 101 that cooperates with a number of other components to enable bingo players, preferably at many different remote gaming sites, to participate in bingo games. Each gaming site includes a local area server (LAS) 102 and a number of electronic player stations (EPSs) 103. As will be discussed in detail below, in the normal operation of gaming system 100, a player at any EPS 103 in the system may participate in a given bingo game with players at any other EPSs 103 in the system. Thus, players at different gaming facilities may be grouped together for a given bingo game administered through system 100. Grouping together players from different gaming facilities for the play of a bingo game allows different bingo games to be played rapidly and minimizes the time that players must wait to receive the result of their participation in the bingo game.

System 100 includes an arrangement for grouping players for the play of a single bingo game to facilitate rapid play. This grouping includes limiting the number of players that participate in a bingo game to reduce the time required to play the game. System 100 reduces the time between a play request at one of the EPSs 103 and the return of results to the respective EPS sufficiently to allow a great deal of flexibility in how results in the bingo game are displayed to the player. In particular, the bingo game results may be displayed in some manner unrelated to bingo. For example, the bingo game results may be mapped to a display traditionally associated with a reel-type game (slot machine), to a display relating to a card game, or to a display showing a race such as a horse or dog race, for example. Preferred techniques for mapping bingo game results to displays associated with games or contests unrelated to bingo are described in U.S. patent application Ser. No. 10/060,643 filed Jan. 30, 2002, and entitled “Method, Apparatus, and Program Product for Presenting Results in a Bingo-Type Game.” The entire content of this prior application is hereby incorporated herein by this reference.

System 100 rapidly groups players and starts one game after another so that multiple games may be in play at any given time. That is, once a first group of players has been assigned to participate in a bingo game offered through system 100, the system proceeds to simultaneously administer a bingo game for the first group of players and also begin grouping players for a next bingo game. System 100 does not necessarily wait for one bingo game to be completed before starting to collect players for and actually beginning play in the next bingo game. The number of players grouped for the play of bingo games according to the present invention may be limited to reduce the time required for grouping players. For example, each bingo game offered through gaming system 100 shown in FIG. 1 may be limited to between 2 to 20 players, with the preferred number of players for any given game being from 10 to 15. Where system 100 includes numerous EPSs 103 at the various remote locations, on the order of several thousand EPSs for example, hundreds of individual bingo games may be in process at any given time through the gaming system.

Regardless of the rapid play facilitated by system 100 and regardless of the manner in which the bingo game results are displayed, the underlying game remains a standard bingo game played in the traditional sequence of play for bingo games. That is, each player obtains or is assigned a bingo card or bingo card representation, all bingo cards in play in the game are daubed or checked for matches with a randomly generated sequence of designations (for example, designations produced in a ball draw or produced by a random number generator), and the first card in the game to match the sequence of designations to produce the game ending winning pattern wins the bingo game. Additional prizes may be awarded for other patterns that may be produced in the course of the bingo game. The mapping of different prizes to various bingo patterns that may be produced in the course of a bingo game in system 100 may be accomplished as described in U.S. Pat. No. 6,569,017, entitled “Method for Assigning Prizes in Bingo-Type Games” or U.S. patent application Ser. No. 10/238,313, filed Sep. 10, 2002, entitled “Prize Assignment Method and Program Product for Bingo-Type Games.” The entire content of each of these prior documents is incorporated herein by this reference.

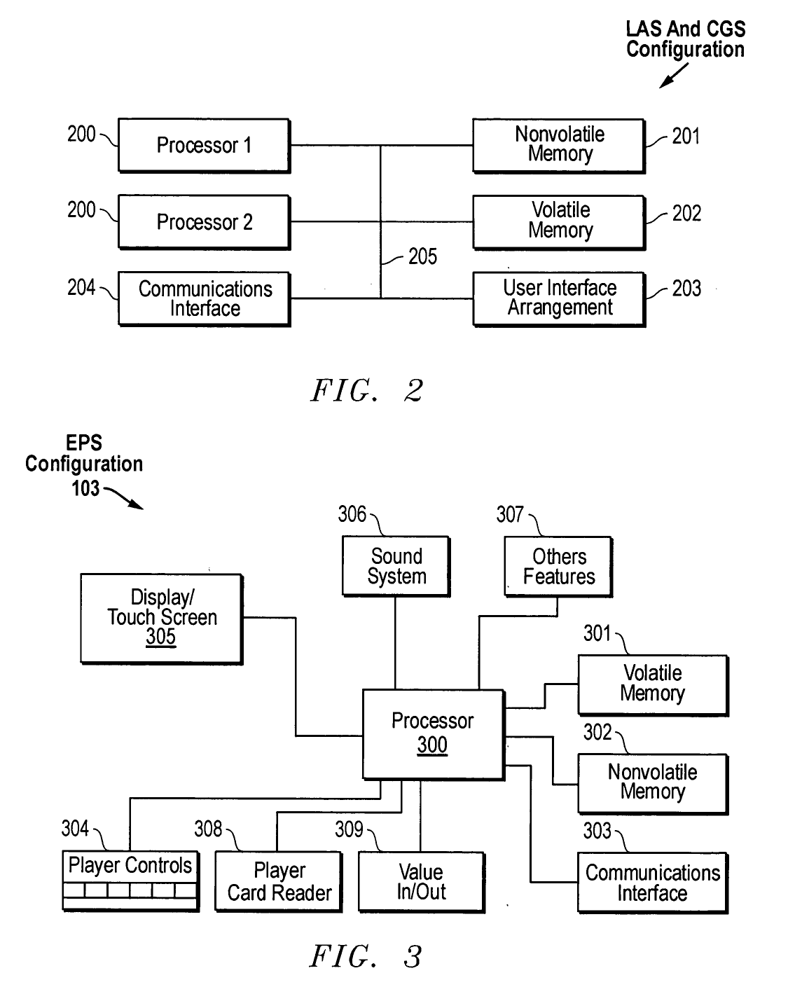

CGS 101 may comprise a computer system such as the basic system shown in FIG. 2. The basic system may include one or more processors 200, nonvolatile memory 201, volatile memory 202, a user interface arrangement 203, and a communications interface 204, all connected to a system bus 205. It will be appreciated that user interface arrangement 203 may include a number of different devices such as a keyboard, a display, and a pointing device such as a mouse or trackball for example. It will also be appreciated that each of these user interface devices will commonly include its own interface to the computer system, although not shown in FIG. 2. Alternatively to the integrated user interface arrangement 203 shown in FIG. 2, a user interface for CGS 101 may be provided through a separate computer (not shown) in communication with the CGS. Regardless of the particular configuration for CGS 101, in the normal operation of system 100 shown in FIG. 1, the CGS functions to group players for participation in bingo games offered through the system, produces or obtains sequences of designations (ball draws, for example) for the play of the bingo games, checks for the results in the bingo games, and communicates the results to LASs 102.

As used in this disclosure, any sequence of designations that may be matched against bingo cards or card representations in the present gaming system will be referred to as a “ball draw” regardless of how the sequence is actually generated. Under this definition, it will be appreciated that a ball draw may be produced by a random number generator, a pseudo random number generator, or any other suitable device or system, and not necessarily a physical ball draw device.

Each LAS 102 included in system 100 as shown in FIG. 1 may comprise a computer system having the same basic structure as shown in FIG. 2. That is, each LAS 102 may include one or more processors 200, nonvolatile memory 201, volatile memory 202, user interface arrangement 203, and communications interface 204 all connected to system bus 205. As with CGS 101, the user interface for the respective LAS 102 may be provided through a separate computer and communications with the LAS rather than the integrated user interface arrangement 203 shown in FIG. 2. Regardless of the specific configuration of the LAS 102, each LAS serves, in normal operation of the system shown in FIG. 1, to transfer or relay information from its respective EPSs 103 to CGS 101 and transfer or relay information from the CGS to the LAS's respective EPSs. Each LAS 102 according to the present invention may also have the ability to group players and actually play bingo games in certain situations. For example, where one LAS 102 serves a large number of EPSs 103, the LAS may group players from its respective EPSs during a time of high player activity, obtain or produce a ball draw, detect the bingo game results, and return results to the EPSs rather than having the CGS 101 perform these tasks. Also, each LAS 102 shown in FIG. 1 may be configured to perform the tasks normally performed by CGS 101 in the event the communications link between the respective LAS and CGS is degraded below a certain level or is severed altogether.

FIG. 3 shows an example of an EPS 103 that may be used in a gaming system embodying the principles of the present invention. The illustrated EPS 103 includes a processor 300, volatile memory 301, nonvolatile memory 302, and a communications interface 303. The volatile and nonvolatile memory stores computer program code that may be executed by processor 300 to cause the processor to perform or direct the various functions provided by EPS 103. Communications interface 303 allows communications between EPS 103 and its respective LAS 102 and/or CGS 101. EPS 103 also includes a user interface arrangement to facilitate player participation in the bingo games offered through gaming system 100 shown in FIG. 1, and display results in an exciting and attractive format. In particular, the user interface arrangement associated with EPS 103 facilitates the play of the underlying bingo game and participation in one or more bonus rounds according to the present invention. A preferred user interface includes player controls 304, a display or touch screen display 305, a sound system 306, and perhaps other features 307 such as alarms or special displays or alerting devices. Each EPS 103 also preferably includes a convenient system for allowing the player to input player-specific information and for receiving wagers and dispensing winnings. For example, the EPS 103 shown in FIG. 3 includes a player card reader 308 that is adapted to read player-specific information from a player account card inserted into the reader. A player account card may, for example, include player information or simply a player identifier encoded on a magnetic medium (mag stripe) associated with the card, or encoded in a bar code, or a memory device associated with the player card. The illustrated EPS 103 also includes a device 309 for receiving value and issuing value in the course of play. This device may accept currency, vouchers, or tokens, for example, and also output currency, vouchers, or tokens. Of course a separate device may be used to receive and issue value for games played according to the present invention. Alternatively or in addition to value in/out device 309, EPSs 103 may read player account information from the player card or player information otherwise input at the EPS, and account for wagers and winnings in the manner set out in U.S. patent application Ser. No. 10/044,478, filed Jan. 10, 2002, entitled “Distributed Account Based Gaming System,” the entire content of which is hereby incorporated herein by this reference.

It will be appreciated that the particular configuration of devices shown in FIG. 1 is shown only for purposes of example. A bingo gaming system or other gaming system that may be used in an implementation of the present invention may omit some or all of the separate LAS's 102 at the various gaming facilities so that the EPS's 103 communicate directly with CGS 101. Also, various regions or different gaming facilities may be divided up into separate systems each having a respective CGS such as CGS 101. In these situations the system could be configured such that a single EPS 103 may be serviced by any of the CGSs. Furthermore, a gaming system embodying the principles of the invention may include multiple CGSs rather than a single CGS 101 as shown in FIG. 1.

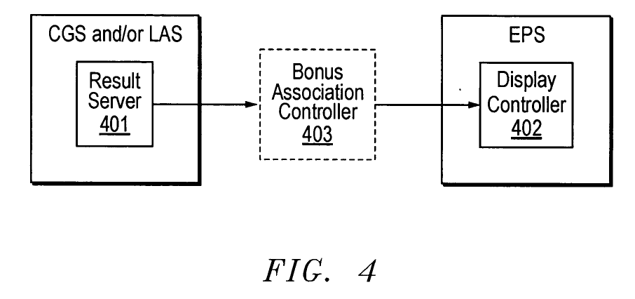

FIG. 4 may be used to describe the components of one embodiment of the present invention as implemented in connection with gaming system 100. The illustrated gaming system includes a result server 401 and a display controller 402. Result server 401 produces, obtains, or identifies a game play result in a game in response to a game play request. Display controller 402 causes the display device (such as display 305 in FIG. 3) associated with an EPS 103 to present the game player with a number of selection options from which to choose during a bonus round according to the present invention. Display controller 402 also causes the display device to conceal the game play result from the game player until the player chooses one of the selection options, and then display the game play result to the game player in response to the game player's selection of any one of the number of selection options. In connection with game play results that are not associated with a bonus round, that is, in connection with non bonus game play results, display controller 402 may also cause the display device to display the non bonus game play result to the player immediately in response to receipt of the non bonus game play result and without presenting any of the selection options presented for game play results associated with the bonus round.

In system 100, result server 401 is implemented in CGS 101 or a LAS 102 depending upon the configuration of the system and the mode of operation at the particular time. That is, either CGS 101 or LASs 102 may be capable of identifying bingo results in system 100, as described more fully in U.S. application Ser. No. 10/456,721, which is incorporated herein. Display controller 402 may be implemented in an EPS 103 in system 100. In particular, display controller 402 may be implemented through software code and processing hardware at EPS 103 used to control the images produced on the display (305 in FIG. 3) associated with EPS 103. Thus, FIG. 4 shows display controller 402 included in an EPS 103.

The details of how a particular result server produces, identifies, or obtains a result for a game play are not critical to the present invention; a result server need only provide the game play result for use by a display controller for controlling the display in the course of game play according to the invention. Thus, many variations are possible for a result server within the scope of the present invention. The result server may be implemented in one or more servers located remotely to the player station and the results may be obtained through the play of a bingo game, games similar to bingo, lottery games, or any other types of games. A result server may even be located at the player station itself within the scope of the present invention. The specific embodiment in connection with system 100 is shown only for purposes of example.

The particular form of the game play result and the manner in which it is communicated to the display controller is also subject to wide variation within the scope of the present invention. A game play result may be a code or index value that is correlated to a result definition at the player station. For example, result server 401 may communicate a bingo result in the form of a coded value and the EPS 103 may query a locally stored look up table to identify the value associated with the game play result, identify the specific bingo pattern achieved in the play of the underlying bingo game, and perhaps symbols or alternative symbols that may be used to display the game play result to the player. Alternatively, result server 401 may communicate a game play result in the form of a set of data specifying the value associated with the game play result, the bingo pattern achieved in the bingo game, and symbols to be used to reveal the game play result to the player. Game play results may be communicated from result server 401 in substantially any form that allows EPS 103 and display controller 402 to perform their functions according to the invention.

It should also be noted that a game play result may also change forms at different points in the processes of the present invention. For example, a game play result may comprise a coded value in the communication from the game server to the player station, but may comprise a representation of a bingo pattern, and prize value as ultimately displayed to the player at a player station. Thus, a game play result as used in the following claims means any identifier or data representing the result or outcome of a game, regardless of the particular form of identifier or data.

Similarly, the specific way in which a display controller operates to perform the display control function is not critical to the present invention. Although display controller 402 is shown implemented with hardware included in an EPS 103 in FIG. 4, those skilled in the art will appreciate that the functions of a display controller may be performed using any number of software techniques and hardware arrangements. For example, all of the processing required to produce the signals used to produce the actual images on the player display may be performed at some location remote to the player station and communicated to the player station through a cable or some other signal communication arrangement.

FIG. 4 also illustrates a bonus association controller 403 interposed between result server 401 and display controller 402. A bonus association controller such as that shown at 403 in FIG. 4 may be employed in some forms of the present invention to produce an association between a given result from result server 401 and the bonus round provided by the present invention. This association between a game play result and a bonus round may be performed in many different ways within the scope of the present invention. In one embodiment the association is made in a random fashion, such as for a randomly selected time of day. In another embodiment, a bonus round is associated with one or more randomly determined bingo card patterns. In another embodiment, bonus round is associated with a randomly determined number of games that a player or a player pool has played. In another embodiment, a bonus round is associated with a randomly determined amount of winnings or losses for a player or a pool of players. In still another embodiment, a game play result is associated with a bonus round at a particular time of day for a particular player station according to a predetermined schedule of elapsed times, such as elapsed playing time, or a predetermined schedule of times of day. In other embodiments, the bonus round is associated with a predetermined number of games played on a player station, or by a particular player, or player pool or a predetermined amount of winnings or losses on a player station, or by a particular player or player pool. In other embodiments of the present invention, bonus association controller 403 may provide the desired association between results in the game and the bonus round according to some predefined relationship. For example, gaming system 100 in FIGS. 1 and 4 may be programmed in advance to associate a bonus round with each occurrence of an “X” pattern, or a “T” pattern, etc. for a player's bingo card. In this example, bonus association controller 403 may include a lookup table in which certain types of results are correlated to a bonus round.

In some embodiments of the present invention the association between game play results and bonus rounds may be done prior to the generation or identification of results. That is, implementations of the invention may simply define certain results possible in the underlying game as being associated with a bonus round. In this case, the result is essentially preassociated with a bonus round in the sense that the result is associated with a bonus round without any affirmative action in the gaming system other than the generation or identification of the given result. These implementations of the invention will include no bonus association controller element considering that the association is predefined. An association between the game play result and bonus round is still performed in these alternate implementations, just not in the course of play of a given game.

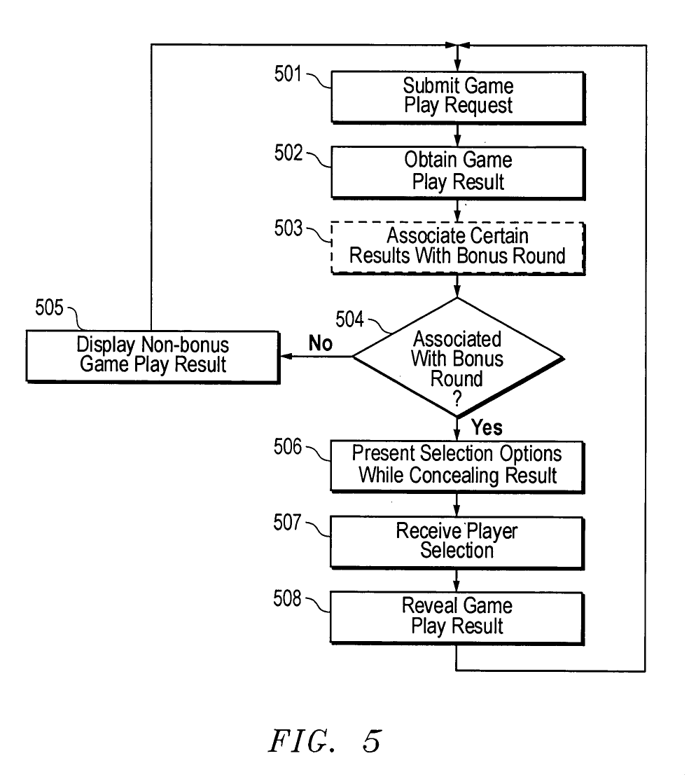

A method according to the invention may be described with reference to the diagram of FIG. 5. In the following description of FIG. 5 it will be appreciated that the references to the physical components are references to the diagrams in FIGS. 1, 2, 3, and 4 that show those components. The illustrated process begins with the submission of a game play request in the game as shown at process block 501. Such a game play request may be submitted from a player station such as an EPS 103 in FIG. 1. The system responds to the game play request by obtaining, producing, or identifying a result in the game or game play result as shown at process block 502 in FIG. 5. This step may be performed by any suitable result server such as a CGS 101 and/or LAS 102 as described above and in related application Ser. No. 10/456,721. The step shown at process block 502 may also be performed by selecting a predetermined result from a sequence of lottery results or by generating a result randomly or according to some algorithm. The process may also include a step such as that shown at process block 503 of associating at least some results with a bonus round as described above in connection with bonus association controller 403 in FIG. 4. Regardless of how the game play result is obtained, and how certain game play results may be associated with bonus rounds, the illustrated preferred process next includes determining whether the respective game play result is associated with a bonus round as indicated at decision block 504. If the game play result is not associated with the bonus round (a non bonus game play result), the player station display shows or displays the non bonus game play result to the player as indicated at process block 505, and then the process returns to wait for the next game play request.

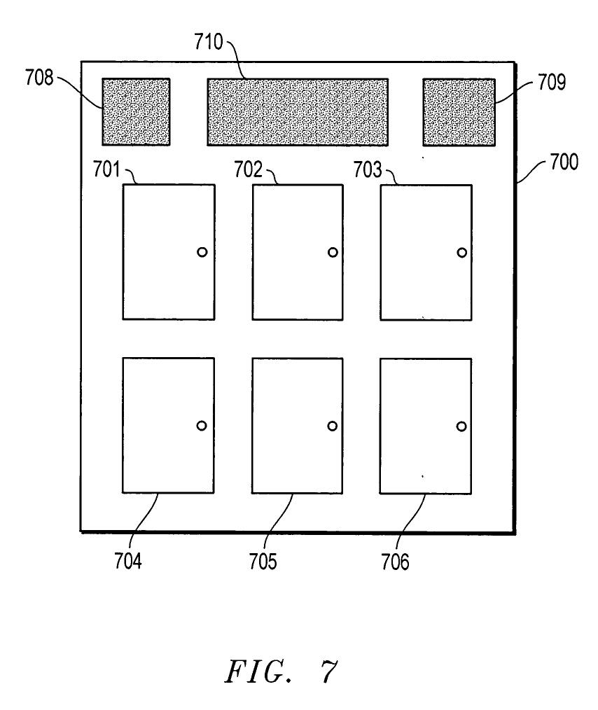

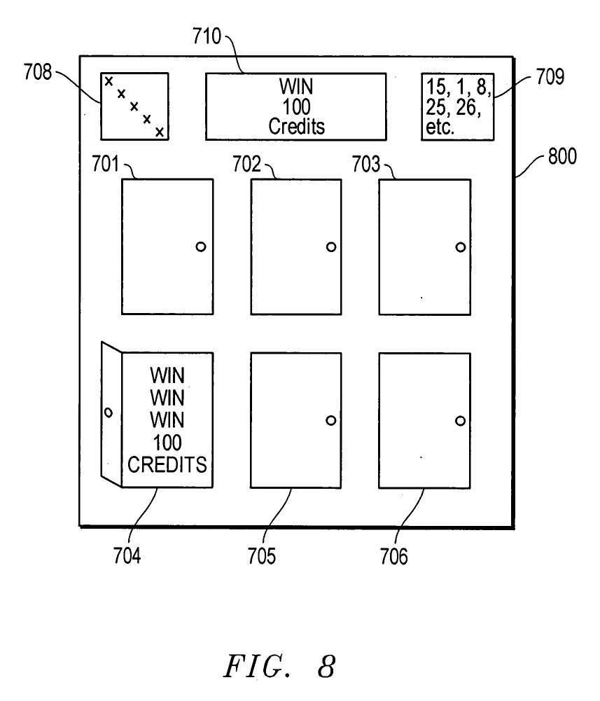

If the game play result is associated with a bonus round, the process includes presenting the player with selection options from which the player may choose as indicated at block 506. It will be noted that this presentation of selection options is performed while concealing the game play result from the player. An example of selection options and the concealment of the result will be described below with reference to FIG. 7. In any event, after presenting the selection options, the system waits for the player to select one of the options. Upon receipt of the selection as indicated at block 507, the process includes revealing or displaying the game play result as indicated at process block 508. From this point, the process returns to wait for the next game play request.

It will be noted from the above process that the bonus round provides for an additional interaction from the game player. In particular, the player selects one of the presented options. However, in the preferred form of the invention the activity by the player in the bonus round has no effect on the result of the game. Rather, the result is predetermined by the result generation or identification process conducted at result server 401 in FIG. 4. The bonus round provides the player with the appearance of making a choice that affects the result of the game. This illusion is possible according to the invention because the result is concealed from the player during the bonus round, that is, in the time period between the time the selection options are presented to the player and the time the player makes their selection.

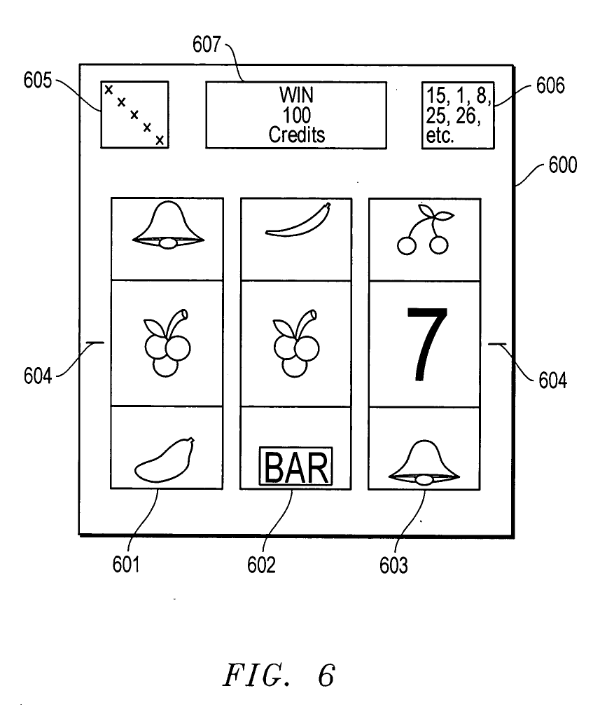

FIG. 6 provides an example of a graphical presentation 600 that may be used to display to the player a game play result that is not associated with a bonus round according to the present invention. The illustrated graphical presentation 600 includes a representation of a series of three reels 601, 602, and 603. These reels correspond to the reels of a reel-type or slot machine and are represented as having various symbols at various reel locations. The symbols displayed in a line such as line 604 are correlated through some payout table with a game play result in the underlying game. That is, a particular level of a win in the game may be related to the player by showing some predefined set of reel symbols across line 604. Graphical presentation 600 is particularly suited for displaying results in an underlying bingo-type game and also includes an area 605 in which the achieved pattern may be displayed. Area 606 may be used to display a “flash board” for the underlying bingo game, that is, the series of numbers called in the bingo game. Area 607 may be used to display animated graphics or other graphics such as the amount of credits won in the game play result.

FIG. 7 illustrates a graphical presentation 700 that may be used in a bonus round embodying the principles of the present invention. Presentation 700 is a graphical display that may be produced under control of the display controller 402 shown in FIG. 4 in response to a game play result that is associated with a bonus round. This particular example includes six different selection options represented by doors 701 through 706. The player is instructed to select one of the doors using player controls associated with the player station. It will be noted that this example shown in FIG. 7 follows the example shown in FIG. 6 with areas 708, 709, and 710 located above the selection options, doors 701 through 706. These display areas may correspond to areas 605, 606, and 607 in FIG. 6, however, it will be appreciated that the areas are greyed out or otherwise covered so as to hide information that would communicate the game play result to the player. Other forms of the invention may simply omit areas 708, 709, and 710 and show only the selection options, in this example, doors 701 through 706.

FIG. 8 provides an example graphical presentation 800 displayed to the player after they have made their selection in the bonus round according to the invention. The player has used the player controls at the player station to select door 704. In this example presentation, the selected door, door 704 has opened to show that the game play result is associated with a value of 100 credits. The example in FIG. 8 also shows the information in areas 708, 709, and 710 corresponding to the game play result. Area 708 shows the bingo pattern achieved in the underlying bingo game, area 709 shows the bingo numbers called in the game, and area 710 shows the number of credits won.

It should be appreciated that the graphical presentations shown in FIGS. 6, 7, and 8 are shown only for purposes of example and are by no means the only presentations that may be used in implementing the present invention. Rather, the graphical presentations that may be used to implement the present invention are limited only be the imagination of the presentation designer. For example, rather than showing objects such as doors as selection options, the objects may be gift-wrapped packages, and the selected package may be unwrapped to display the given game play result. Also, the presentation may provide any number of interesting and exciting graphics in the course of revealing the game play result after the player has made their selection. For example, in the example of a number of doors from which the player may select, once the player has made their selection the selected door may expand on the display and the other doors may disappear from the display. Continuing along with this example, the presentation may show an animated person representing the player or a character for the player, who enters though the opened door and does battle with a dragon for example. The outcome of the battle may be correlated to the underlying game play result, which is ultimately shown on the display once the animation is complete.

In other embodiments the choice available in the bonus round is presented to the player as a choice of contestants for a contest. In one such contest-choice type embodiment, the EPS 103 graphically represents a horse race and indicates that the player is to select one of the horses in the race. In another such embodiment, the player station graphically represents a spinning wheel and indicates that the player is to select one of the numbers on the wheel. This presentation adds an aspect missing from the previously described pick-a-door arrangement, for example. That is, according to the pick-a-door arrangement there is no indication whether there is anything better or worse about the doors that the player does not pick as compared with the door that the player does pick. However, according to the horse race embodiment, for example, responsive to receiving the player selection, the player station shows the race (contest) outcome and may show the entire race. The player station would also reveal any prize associated with the race outcome consistent with the underlying game play result. Thus, the contest embodiments provide another opportunity to reveal something to the player, which tends to create more suspense and thereby better maintain or capture the player's interest. That is, there is an additional aspect of revealing whether the user's choice is a “winning” choice in terms of the racing of the horses, independent of revealing the underlying game play result. It should be understood, of course, that winning or losing the horse race still has no effect on the amount of the predetermined prize for the underlying game play result. That is, while the predetermined-prize bonus round may depend on the game play result, as described above, the game play result is independent of the occurrence of the bonus round.

It will also be appreciated that the invention is not limited to a single bonus round or to single bonus round activities such as the selection of a single object from several objects presented as selection options. In the dragon battle animation described above, for example, a victorious outcome of the battle might end up with a presentation showing the player a second set of selection options from which to choose. The underlying game play result in this example would be revealed to the game player after the player makes a selection from this second set of selection options. In yet other implementations of the present invention the player may be required to do something more than simply picking an object or picking a contestant. For example, a player may be required to make multiple inputs to make their selection or even control a contestant in an animated contest or battle. In these multiple input selection embodiments, all of the multiple inputs may be considered the player's selection according to the invention.

Many other features may be incorporated into the animations or displays for bonus rounds according to the invention. For example, a notification device or alarm associated with the player station may be activated when a game play result is associated with a bonus round. The notification device or alarm may draw attention to the respective player station and the following selection or selections and animation for the bonus round.

From the above, it should be understood that even though the player is presented with a choice, such as a choice of doors, and even though the added activity resulting from occurrence of a predetermined-prize bonus round is herein referred to as a “bonus round,” the predetermined-prize bonus round is a bonus round only in that it entitles the player to take some action that appears as a choice among different alternatives, but not in terms of credits won for a given game play request. The player's choice during the predetermined-prize bonus round has no effect on the prize amount for the game and the amount won for the game accordingly is no greater or less than would be the result without the bonus round. That is, a predetermined amount of credits for the game is set by the game server. This amount of credits is determined in advance of the player choice during the “bonus round,” such as the choice of a door to open.

In various embodiments a gaming system according to the present invention may take a variety of forms, including a personal computer system, mainframe computer system, workstation, Internet appliance, PDA, an embedded processor with memory, etc. That is, it should be understood that the term “computer system” is intended to encompass any device having a processor that executes instructions from a memory medium. The memory medium preferably stores instructions (“a software program”) for implementing various embodiments of a method in accordance with the present invention. In various embodiments, the one or more software programs are implemented in various ways, including procedure-based techniques, component-based techniques or object-oriented techniques, among others. Specific examples include XML, C, C++ objects, Java and class libraries. However, it will be appreciated that the invention is not limited to any particular hardware or software implementation.

The above-described embodiments have been presented for purposes of illustration, but are not intended to be exhaustive or to limit the invention to the forms disclosed. Many additional aspects, modifications and variations are also contemplated and are intended to be encompassed within the scope of the following claims. Moreover, it should be understood that in the following claims actions are not necessarily performed in the particular sequence in which they are set out unless a particular sequence is explicitly indicated. Furthermore, the information or data communicated or distributed in the various processes of the present invention are capable of being distributed in a variety of forms. The present invention applies equally regardless of the particular type of signal bearing media actually used to carry out the distribution. Examples of computer readable media include RAM, flash memory, recordable-type media such as a floppy disk, a hard disk drive, a ROM, CD-ROM, DVD and transmission-type media such as digital and/or analog communication links, including those used for Internet communications.

1. A method of providing a predetermined-prize bonus round in a game, the method including the steps of:
(a) associating a respective game player's game play result with a predetermined-prize bonus round;
(b) presenting the game player with a number of selection options from which to choose during the predetermined-prize bonus round;
(c) concealing the game play result from the game player during the predetermined-prize bonus round until the game player selects one of the selection options; and
(d) displaying the game play result to the game player in response to the game player's selection of any one of the number of selection options.

2. The method of claim 1 further including the step of responding to the receipt of a non-bonus round game play result by displaying the non-bonus round game play result to the game player, the non-bonus round game play result not being associated with the predetermined-prize bonus round.

3. The method of claim 1 wherein the game comprises a bingo-type game and the game play result includes a bingo card pattern.

4. The method of claim 1 wherein the step of associating the game play result with the predetermined-prize bonus round is performed in response to a random event.

5. The method of claim 1 wherein the step of associating the game play result with the predetermined-prize bonus round is performed in response to a predetermined event.

6. The method of claim 1 wherein the step of associating the game play result with the predetermined-prize bonus round is performed according to a predetermined relationship between the game play result and the predetermined-prize bonus round.

7. The method of claim 1 wherein:
(a) the step of presenting the game player with the number of selection options from which to choose during the predetermined-prize bonus round includes the step of presenting a graphical depiction of a number of objects from which to select; and
(b) the step of displaying the game play result to the game player includes displaying a graphical depiction in which the game play result is revealed in connection with the selected object in response to the game player's selection of the selected object.

8. The method of claim 1 wherein:
(a) the step of presenting the game player with the number of selection options from which to choose during the predetermined-prize bonus round includes the step of presenting a graphical depiction of a number of objects representing respective participants in a contest; and
(a) the step of displaying the game play result to the game player includes presenting a graphical depiction of an outcome of the contest responsive to receiving the game player's selection.

9. A system for providing a predetermined-prize bonus round in a game, the system including:
(a) a player station being operable to generate a game play request in response to an input by a respective player, the player station including a display device;
(b) a game server operable to identify a game play result for the game play request; and
(c) a display controller for causing the display device to present the game player with a number of selection options from which to choose during a predetermined-prize bonus round associated with the game play result, to conceal the game play result from the game player during the predetermined-prize bonus round until the game player chooses one of the selection options, and to display the game play result to the game player in response to the game player's selection of any one of the number of selection options.

10. The system of claim 9 further including a bonus association controller for associating the game result with the predetermined-prize bonus round.

11. The system of claim 10 wherein the bonus association controller associates the result with the predetermined-prize bonus round in response to a random event.

12. The system of claim 10 wherein the bonus association controller associates the result with the predetermined-prize bonus round in response to a predetermined event.

13. The system of claim 10 wherein the bonus association controller is located with the game server.

14. The system of claim 10 wherein the bonus association controller is located with the player station.

15. The system of claim 9 wherein the display controller presents the game player with the number of selection options by presenting a graphical depiction of a number of objects, and wherein the player station responds to the game player's selection by presenting a graphical depiction in which the game play result is revealed in connection with the selected object.

16. The system of claim 9 wherein the display controller presents the game player with the number of selection options by presenting a graphical depiction of a number of objects representing respective participants in a contest, and wherein the player station responds to the game player's selection by presenting a graphical depiction of an outcome of the contest.

17. The system of claim 9 wherein the display controller is also operable to cause the display device to display a non-bonus game play result to the game player in response to the receipt of the non-bonus game play result.

18. A program product for communicating a game play result to a game player, the program product being stored on a computer readable medium and including:
(a) selection option display program code for responding to a game play result associated with a predetermined-prize bonus round by causing a player display to present the game player with a number of selection options from which to choose; and
(b) bonus round display program code for causing the player display to display the game play result to the game player in response to the game player's selection of any one of the number of selection options.

19. The program product of claim 18 further including primary display program code for responding to a non-bonus game play result by causing the player display to display the non-bonus game play result.

20. The program product of claim 18 further including bonus round associating program code for associating a game play result with the predetermined-prize bonus round to categorize the game play result as the second type game play result.

21. The program product of claim 18 wherein the bonus round associating program code associates the game play result with the predetermined-prize bonus round in response to an event unrelated to the game play result.

22. The program product of claim 18 wherein the selection option display program code causes the player display to present a graphical depiction of a number of objects from which the game player selects, and wherein the bonus round display program code causes the player display to present a graphical depiction in which the game play result is revealed in connection with a respective one of the objects in response to the game player's selection of the respective object.

23. The program product of claim 18 wherein the selection option display program code causes the player display to present a graphical depiction of a number of contestants from which the game player selects, and wherein the bonus round result display program code causes the player display to present a graphical depiction in which the game play result is revealed as an outcome of a contest between the number of contestants in response to the game player's selection of a respective one of the contestants.
